(19) United States
(12) Patent Application Publication
(10) Pub. No.: US 2024/0213891 A1
(43) Pub. Date: Jun. 27, 2024

(54) Electrical Current Generation by magnetic field manipulation via the Meissner Effect

(71) Applicant: Lewis Stockton Kinsey, Lincoln University, PA (US)

(72) Inventor: Lewis Stockton Kinsey, Lincoln University, PA (US)

(21) Appl. No.: 18/071,520

(22) Filed: Nov. 29, 2022

(51) Int. Cl. H02N 11/00

(52) U.S. Cl. CPC H02N 11/002

(57) ABSTRACT

A superconductor producing the Meisner Effect will expel a magnetic field when passing near a magnetic surface. The movement of the magnetic field expelled by the superconductor will produce an electrical current in an electrically conductive coil that is adjacent to the superconductor while it expels the magnetic field due to the Meisner effect.

### BACKGROUND OF THE INVENTION

When a superconductive substance has been cooled below its superconducting critical temperature, it expels nearly all magnetic fields—this phenomenon is known as the Meissner effect.

### Field of the Invention

The present invention applies to electrical current generation. Particularly, the invention applies to novel methods and devices to generate electrical currents by manipulation of magnetic fields using the Meissner effect.

### Description of Related Art Including Information Disclosed Under 37 CFR 1.97 and 1.98

This present invention uses the previous art of the Meissner effect to manipulate magnetic fields to generate an electrical current. One embodiment of the invention is demonstrated by the figures below.

### BRIEF SUMMARY OF THE INVENTION

This present invention uses superconductors cooled below their superconducting temperature, while traversing an arrangement of magnets, to create movement in their magnetic fields. The movement of these magnetic fields across an electrically conductive coil will generate an electrical current. The movement of these magnet fields affected while the superconductor passes through their magnetic fields is known as the Meissner effect.

### BRIEF DESCRIPTION OF THE SEVERAL VIEWS OF THE DRAWING(S)

FIG. 1 is front-facing diagram of the general shape of magnetic fields.

FIG. 2 shows a superconducting material in two different states.

FIG. 3 is a front facing diagram of the arrangement of magnets.

FIG. 4 shows an embodiment in which magnets (2) are arranged as in FIGS. 1 and 3 but the pattern has been extended to create a long axis (this will be the forward-backward direction).

### DETAILED DESCRIPTION OF THE INVENTION

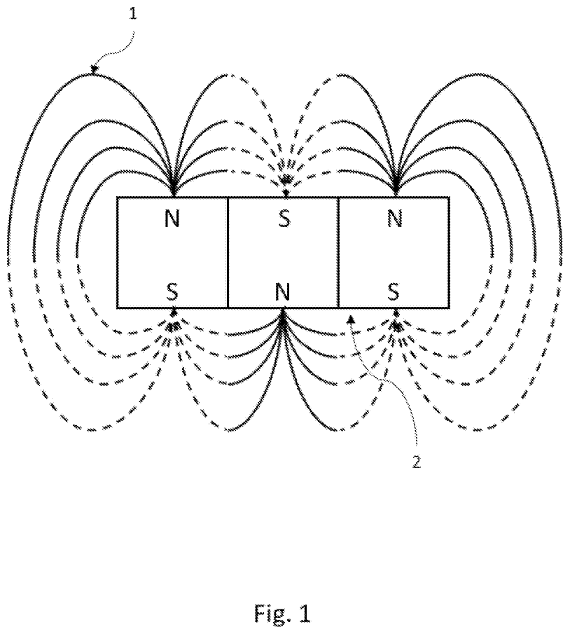

FIG. 1 is front-facing diagram of the general shape of magnetic fields (1) when magnets (2) are arranged in alternating poles.

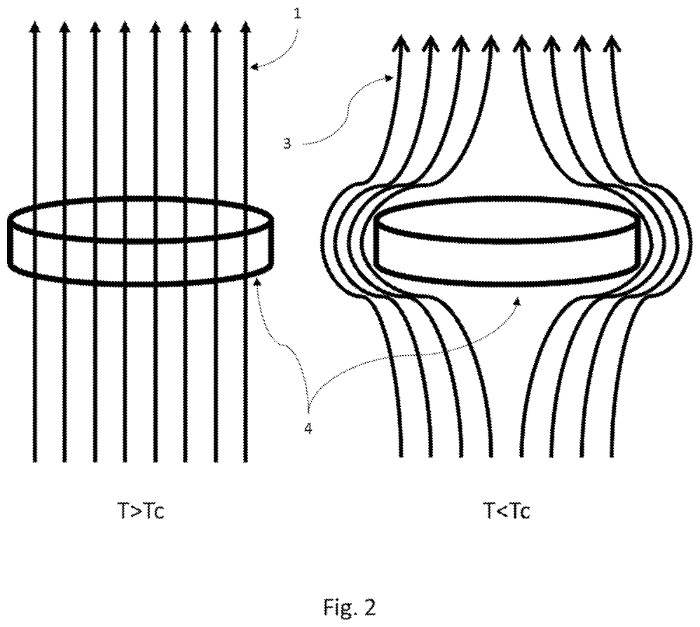

FIG. 2 shows a superconducting material (4) in two different states: on the left, the superconductor is at a temperature above the superconducting critical temperature in which the magnetic field lines are unperturbed by the superconductor (1) while on the right, the superconductor is at a temperature below the superconducting critical temperature in which the magnetic field lines are expelled from within the superconductor (3) i.e. the Meissner effect.

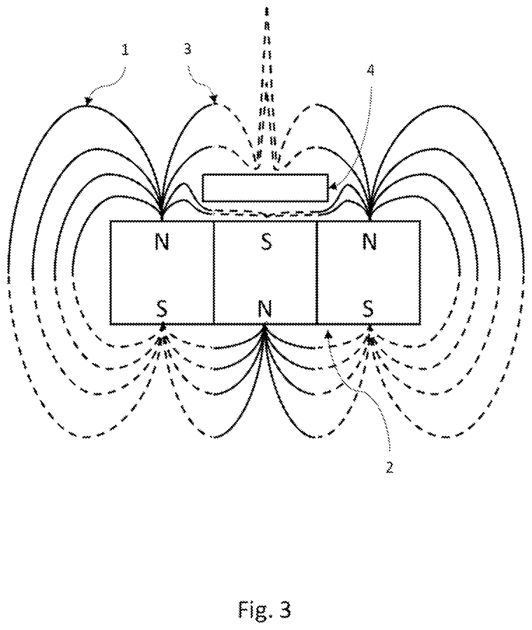

FIG. 3 is a front facing diagram of the arrangement of magnets (2) in FIG. 1 but with a superconductor (4) below the superconducting temperature in an equilibrium state (in which it will not move to the right or left or up or down) via the Meissner effect above the central magnet.

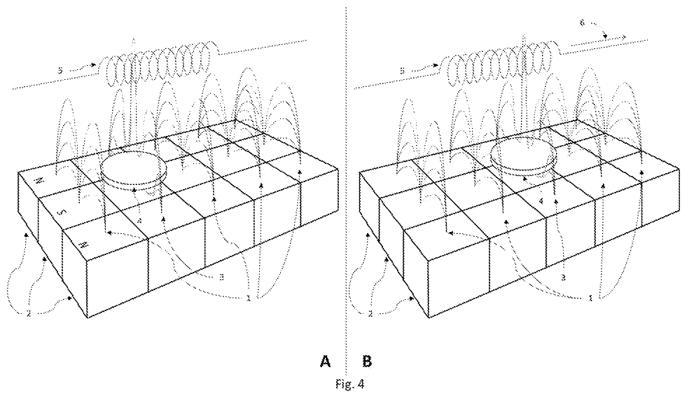

FIG. 4 shows an embodiment in which magnets (2) are arranged as in FIGS. 1 and 3 but the pattern has been extended to create a long axis (this will be the forward-backward direction). A superconductor (4) below the superconducting critical temperature can move freely forwards and backward along the center of magnetic configuration in an equilibrium state (but not moving from left to right or up or down from the perspective of FIG. 3). There is an electrically conductive coil (5) above this configuration. As the superconductor moves, it expels the magnetic fields (3) that would have gone through it, altering the magnetic field (1) as shown from part A to B. As the magnetic field has moved across the electrically conductive coil from A to B, a current (6) has been generated.

2. A device for producing electrical current by changing magnetic fields via Misner effect, that is comprised of a magnetic field, a superconductor, and a conductor connected to a circuit.
